(19) United States
(12) Patent Application Publication
(10) Pub. No.: US 2006/0178943 A1
(43) Pub. Date: Aug. 10, 2006

(54) Food order fulfillment system deploying a universal in-store point-of-sale (POS) for preparation and pickup scheduling

(76) Inventors: Joseph R. Rollinson, San Diego, CA (US); David Romero, San Diego, CA (US)

Correspondence Address: JAMES ALBERT WARD, 6924 CAMINO PACHECO, SAN DIEGO, CA, 92111, US

(21) Appl. No.: 11/236,334

(22) Filed: Sep. 27, 2005

Related U.S. Application Data
(62) Division of application No. 11/031,323, filed on Jan. 7, 2005, now abandoned.

(51) Int. Cl. G06Q 30/00

(52) U.S. Cl. 705/26

(57) ABSTRACT

A remote ordering system including a universal in-store point-of-sale (POS) system deployed to allow a remote-ordering user to customize, pay and transmit a food order to a vending merchant and to provide means for transmitting to the user a confirmation of receipt of the food order in real time together with a merchant commitment to a precise pickup time, thereby facilitating food order fulfillment immediately upon user arrival at the committed pickup time. One aspect of the invention allows a “curb-side” remotely-ordering user to notify the vending restaurant of arrival for fulfillment through a telephone call to an interactive voice response element, which then transmits an arrival notification message to the restaurant.

### BACKGROUND OF THE INVENTION

1. Field of the Invention

This invention relates generally to food order processing systems and more particularly to a food order processing system that deploys a universal wireless in-store point-of-sale (POS) system for use in scheduling food preparation and pick-up time.

2. Description of the Related Art

Customers consistently reward merchants who can make it easier and faster for them to buy their goods and/or services. Knowing this, merchants generally try to implement business methods and systems designed to facilitate this end, provided that the financial benefits outweigh the additional costs of such practices. In particular, for restaurants, the ordering and payment processes can require as much labor as does the actual food preparation. A similar transaction overhead problem exists for many other types of merchants. Thus, business methods for automating these pure transaction tasks have the added benefit of saving labor resources and increasing overall sales capacity.

For example, the success of “drive-thru” ordering methods in the fast food restaurant business and automated voice-response phone ordering methods in the retail pharmacy business illustrate the benefits available from improving the ordering process. As another example, business methods are known in the restaurant art for facilitating the remote placement of customer orders by means of an Internet website or telephone number, thereby reducing customer wait time during order fulfillment (delivery/pick-up) at the restaurant. However, such business methods do not appear to be widely accepted in the restaurant art because of one or more of the following typical disadvantages.

For example, many such restaurant food ordering and fulfillment business methods transmit food order information by means of a telefax or email message to the vending restaurant. If the telefax line is busy or the email delivery is not monitored by responsible staff, the food order may not be timely prepared and ready for delivery/pick-up when the customer arrives at the restaurant. Often the food order is not ready at customer arrival because of such transmission failure or because the restaurant was too busy to schedule timely fulfillment of the order. Moreover, if the food order is prepared too early, the customer may be dissatisfied with the quality (temperature, freshness, etc.) at order fulfillment, thereby damaging the reputation of the vending restaurant. As another example, many such business methods do not provide any means for pre-payment of the food order, obliging the customer to wait for payment processing after arriving for order delivery/pick-up.

Practitioners in the restaurant business arts are aware of these and other related disadvantages and have proposed a variety of solutions. For example, some practitioners have proposed remote ordering systems adapted to be integrated with an existing merchant point-of-sale (POS) system, but such systems generally require individualized and costly in-store system reconfiguration and oblige the merchant to buy new communications services, such as a dedicated phone line for a modem or additional means for connecting to the Internet. The associated costs for new hardware, connectivity, installation, reconfiguration and training often outweigh the financial benefits to the merchant of such business systems. Such systems are generally limited in application to particular POS systems, requiring a special customized configuration for each particular POS system. While such business systems may be well-adapted to facilitate food order fulfillment for a particular vending restaurant, this particularity disadvantageously increases the cost of every such system and obliges customers to learn how to order through a different interface for each vending restaurant, for example.

Other practitioners have proposed food order processing systems that oblige users (customers) to plan the remote ordering process perhaps as much as an hour in advance of actual fulfillment. For example, such a system may not provide for a vending restaurant commitment to prepare a remotely-placed order within a predetermined time and the user is obliged to accept some standard fulfillment time interval (as long as 30 minutes or more), and may need to wait for an indeterminate period after arriving for fulfillment of even a pre-paid remotely-placed food order. Such disadvantages also oblige the vending restaurant to accommodate an unpredictable number of food order changes and cancellations arising from indeterminate delays in order fulfillment, for example.

As yet another example, many proposed food order processing systems provide no means for quickly and easily identifying and linking the remotely-ordering user to the proper remotely-placed food order upon arrival for order fulfillment. When the vending restaurant is busy (a very common situation during mealtimes) the usual identification and linking problem obliges the arriving remotely-ordering user to either wait in a queue with nonusers after arrival for an indeterminate period or to essentially cut in line to advise the vending restaurant staff of their arrival for fulfillment of a particular remote food order. Some remote ordering systems known in the art provide a separate cash register and sign (i.e., “Phone-In Order Pickup”) at the vending restaurant for such remote-ordering users, but the separate register disadvantageously increases remote order transaction costs because of the associated labor and equipment.

As yet another example, some proposed food order processing systems include additional means for food order fulfillment to a remotely-ordering user at the user vehicle, sometimes denominated “curb-side” service. Such additional in-vehicle fulfillment means is often desirable to remotely-ordering users (e.g., those in a hurry or with small children) and thereby is quite advantageous to vending restaurants that are not provided with the typical “drive-thru window.” Various means are known in the art for receiving notification of arrival of the remotely-ordering user vehicle, such as, for example, a video camera, a reserved parking spot, and various external apparatus disposed in the parking lot and/or the arriving vehicle.

There is accordingly a clearly-felt need in the art for a remotely-placed food order processing and fulfillment method and system that provides means for resolving these and other disadvantages. These unresolved problems and deficiencies are clearly felt in the art and are solved by this invention in the manner described below.

### SUMMARY OF THE INVENTION

This invention solves these problems by providing a remote ordering system including a universal in-store point-of-sale (POS) system deployed to allow a remote-ordering user to customize, pay and transmit a food order to a vending merchant and to provide means for transmitting to the user a confirmation of receipt of the food order in real time together with a merchant commitment to a precise pickup time, thereby facilitating food order fulfillment immediately upon user arrival at the committed pickup time. The system of this invention may also include means for immediate user identification and linkage to the food order to completely eliminate fulfillment delay. For example, one aspect of the invention allows a “curb-side” remotely-ordering user to notify the vending restaurant of arrival for fulfillment through a telephone call to an interactive voice response element, which then transmits an arrival notification message to the restaurant.

It is a purpose of this invention to provide immediate food-order fulfillment to any user from any food vendor equipped with a universal in-store POS system that may be deployed anywhere and coupled to the fulfillment system of any food vendor without adaptation.

In one aspect, the invention is a machine-implemented method for processing a food order from a user, including the steps of (a) accepting the food order from the user by performing the steps of (a.1) displaying a plurality of food merchants, (a.2) accepting a merchant selection from the user, (a.3) displaying a merchant menu that includes merchant inventory availability and pricing data, (a.4) accepting a menu item selection from the user, (a.5) displaying a merchant preparation time for the food order, and (a.6) debiting a user account for the price of the food order; (b) providing to the user a pick-up time and a pick-up location for the food order by performing the steps of (b.1) accepting at the in-store POS system digital data corresponding to the food order and a user identity, (b.2) receiving from the in-store POS system a wireless signal representing digital data corresponding to a confirmation of receipt of the food order by the selected merchant, and (b.3) displaying the pick-up time for the food order; and (c) fulfilling the food order for the user at the order pickup location.

In another aspect, the invention is a system for the processing of a food order from a user, the system including order acceptance means for accepting the food order from the user, including first means for displaying a plurality of food merchants, second means for accepting a merchant selection from the user, third means for displaying a merchant menu that includes merchant inventory availability and pricing data, fourth means for accepting a menu item selection from the user, fifth means for displaying a merchant preparation time for the food order, and sixth means for debiting a user account for the price of the food order; confirmation means for establishing a pick-up time and a pick-up location for the food order, including first means for accepting at the in-store POS system digital data corresponding to the food order and a user identity, second means for receiving from the in-store POS system a wireless signal representing digital data corresponding to a confirmation of receipt of the food order by the selected merchant, and third means for displaying the pick-up time for the food order; and fulfillment means for fulfilling the food order for the user at the order pickup location.

In a preferred embodiment, the invention is a point-of-sale (POS) system for use in a system for the processing of a food order from a user, the POS system including reception means for receiving a wireless signal representing digital data corresponding to the food order, printer means for printing the food order to produce a permanent record thereof, and processor means for adding the food order into a food order database.

The foregoing, together with other objects, features and advantages ofthis invention, can be better appreciated with reference to the following specification, claims and the accompanying drawing.

### BRIEF DESCRIPTION OF THE DRAWINGS

For a more complete understanding of this invention, reference is now made to the following detailed description of the embodiments as illustrated in the accompanying drawing, in which like reference designations represent like features throughout the several views and wherein:

FIG. 1 is a block diagram illustrating an embodiment of the food order fulfillment system of this invention;

FIG. 2 is a flow diagram illustrating an embodiment of the food order fulfillment method of this invention;

FIGS. 3A-D are schematic diagrams illustrating several useful hardware embodiments of the deployed in-store Point-Of-Sale (POS) system of this invention from FIG. 1;

FIG. 4 is a block diagram illustrating a useful embodiment of the software elements of the deployed in-store POS system of this invention from FIG. 1;

FIG. 5 is a flow diagram illustrating an embodiment of the real-time transmission and confirmation method of this invention from FIG. 2;

FIGS. 6A-D are schematic diagrams illustrating the method of this invention by which a user and merchant obtain an exact pickup time, including exemplary food vendor data structures and associated graphical user interface (GUI) displays;

FIG. 7 is a flow diagram illustrating an embodiment of the walk-in pick-up method of this invention from FIG. 2;

FIG. 8 is a flow diagram illustrating an embodiment of the curb-side pick-up method of this invention from FIG. 2;

FIG. 9 is an entity relationship diagram illustrating a useful embodiment of the user, merchant and product data structures of this invention;

FIGS. 10A-Q are data structure diagrams illustrating examples of the user, merchant and product data structures of this invention; and

FIGS. 11A-L are schematic diagrams illustrating the GUI displays associated with the method of this invention from FIG. 2.

### DETAILED DESCRIPTION OF THE EMBODIMENTS

Introduction:

The food order fulfillment system ofthis invention addresses the need for a cost-effective order processing method that can be easily configured, installed and operated by many different merchants to accept remote orders from their customers (herein denominated “users”). For example, the unpredictable order completion time problem is resolved by allowing each merchant to commit to a static order preparation time, which is used to generate an exact pickup time for both the user and food vendor staff. With these problems resolved, system users (customers) know exactly how far in advance they need to place an order, which advance time is often much less than required for existing remote-ordering systems. In practice, most merchants require only 10 to 15 minutes advance notice of food orders, permitting users to order in the office or home just before leaving to pick-up the order, thereby eliminating most reasons for order cancellation or modification by the user. As another example, the combination of remote ordering, pre-payment, real-time transmission, exact pickup time and identification (ID) pickup procedures assure users of a rapid hassle-free transaction. The universal point-of-sale (POS) system of this invention is self-sufficient and may be quickly installed at any food vendor store without requiring special adaptation of the hardware or software. This important feature of the food-order fulfillment system of this invention permits the simple and rapid addition of any food vendor into the food-order fulfillment system user network. And with many food merchants to choose from, there is more incentive for users to use it. As yet another example, the food-order fulfillment system of this invention addresses the timing problem of curb-side pick-ups by allowing the customer to call into an in-store Interactive Voice Response (IVR) phone system upon arrival, and with a few quick keystrokes identify themselves to the system and indicate that they are on the premises. The IVR system then transmits a signal to the in-store POS system, which sounds a special arrival alert and prints out the customer vehicle information for use in immediate fulfillment, for example.

System Overview:

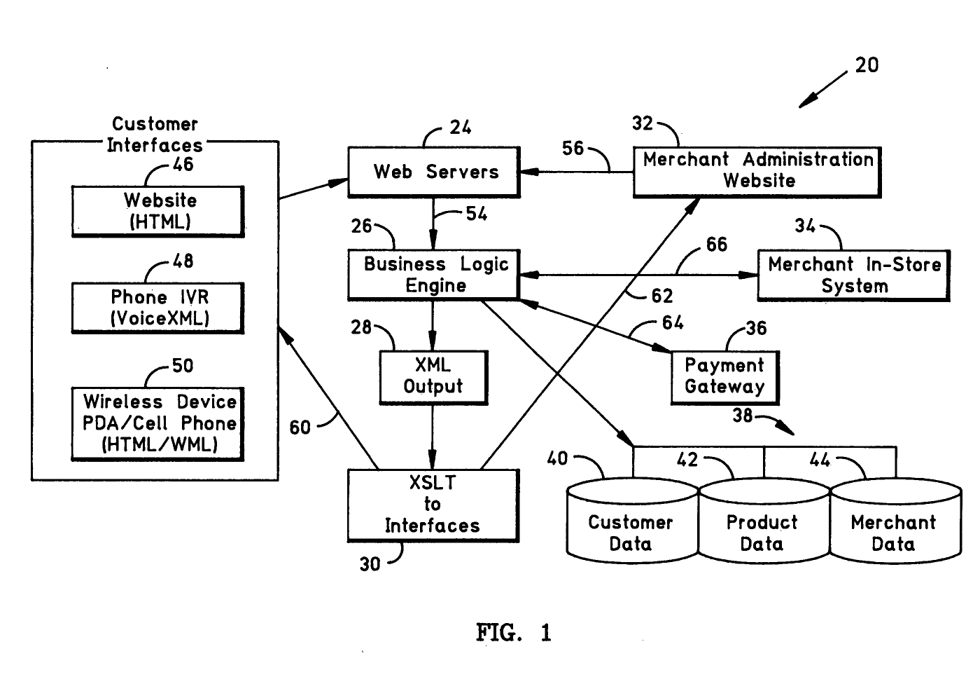

FIG. 1 illustrates the food order fulfillment system 20 of this invention. Generally, system 20 includes the various user interfaces 22, one or more web servers 24, the Business Logic Engine 26, the XML Output 28, a XSLT transformation layer 30, at least one Merchant Administration Website 32, a Merchant In-Store POS System 34, a Payment Gateway 36, and at least one database 38 for storing the customer data 40, the product data 42 and the merchant data 44. User interfaces 22 may include a web browser 46 using HTML to access a website (not shown) residing in web server 24, a web-served VoiceXML interface 48 for controlling an in-store interactive voice response (IVR) system (not shown), and one or more wireless device interfaces 50 requiring specialized HTML or other markup languages for these devices such as WML or BREW. Alternatively, the user may employ an intermediary by, for example, speaking by telephone with a call center representative who is disposed to submit requested user actions through user interfaces 22.

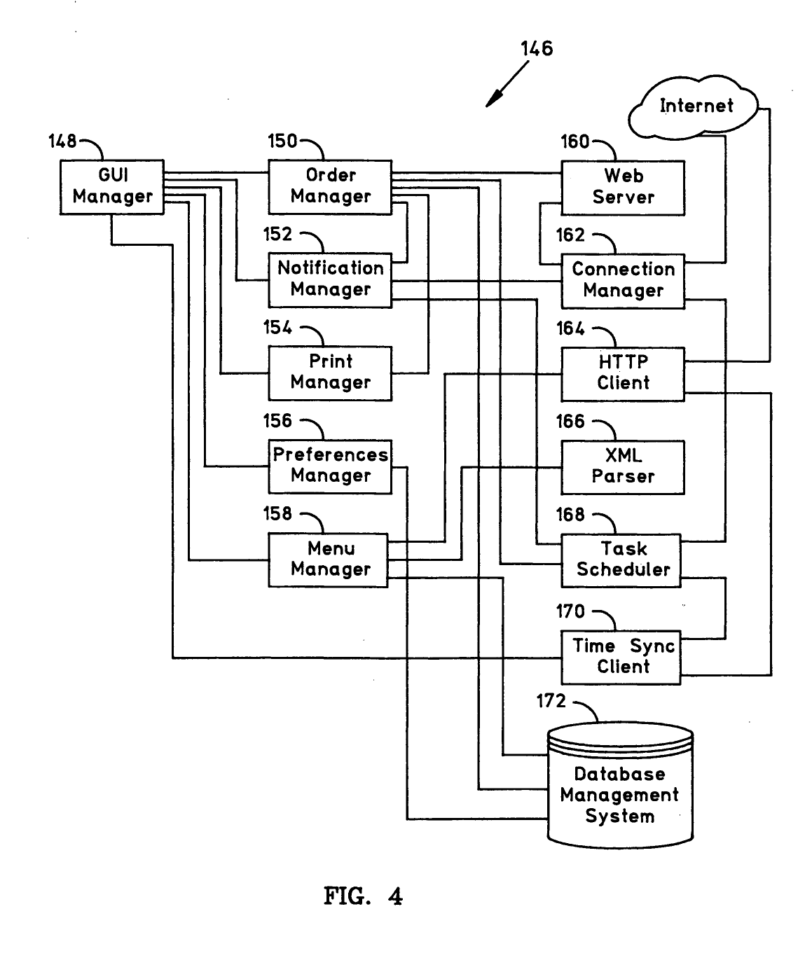

User interfaces 22 should post all of the user action data 52 to web servers 24 running web server software such as, for example, Apache or Microsoft IIS or any other useful web server software. Web servers 24 communicate the actions posted through user interfaces 22 to Business Logic Engine 26, which includes a plurality of software code objects (FIG. 4). Web servers 24 also interact with Merchant Administration Website 32, within which a merchant may create and maintain the related merchant and product data 56.

Business Logic Engine 26 employs, for example, object-oriented PHP classes, or any other well known useful object-oriented software/languages such as Perl, Microsoft ASP or Java Server Pages, without limitation. The layer of code and logic within Business Logic Engine 26 operates to accept the user input data 54 relayed from web servers 24, to retrieve the associated data 58 from databases 38, to communicate with payment gateway 36 when appropriate and to communicate with Merchant In-Store POS System 34. Customer data 40, product data 42 and merchant data 44 are stored and served by database 38, which should include a relational database management system (not shown) such as a MySQL database system, or any other useful RDBMS system, such as PostgreSQL, Microsoft SQL Server or Oracle, without limitation. Business Logic Engine 26 is disposed to automatically serve up whatever product data 42 and merchant data 44 exists in database 38, so that all user interfaces 22 are serving real-time data incorporating any additions or changes made by merchant staff immediately and automatically. Business Logic Engine 26 sends the appropriate data 60 to user interfaces 22 and the appropriate data 62 to merchant administration website 32 by first producing XML output 28 and then calling the appropriate style-sheet in XSLT transformation layer 30 to transform XML output 28 into the appropriate markup format (e.g. HTML, VoiceXML, WML, or BREW). The details of this markup formatting practice are well-known in the art and are readily appreciated by a skilled practitioner with reference to, for example, the TopXML website publication (regarding the use of XSLT with VoiceXML) [http://www.vbxml.com/xsl/articles/voicexml_xslt/default.asp], or the IBM website publication (regarding the creation of mobile interfaces with XSLT) [http://www-106.ibm.com/developerworks/wireless/library/wi-tip15/].

When the ordering activity requires payment collection on behalf of the merchant, Business Engine Logic 26 sends the user's payment information along a data link 64 to payment gateway 36, which operates to obtain authorization for the needed funds. For example, payment gateway 36 may connect to an outside payment authorization network (e.g., Authorize.net) and establish a secure sockets layer (SSL) connection for transfer of the appropriate user authorization data (not shown), accepting the return of either successful authorization or declined transaction and communicating this back to Business Engine Logic 26 over data link 64.

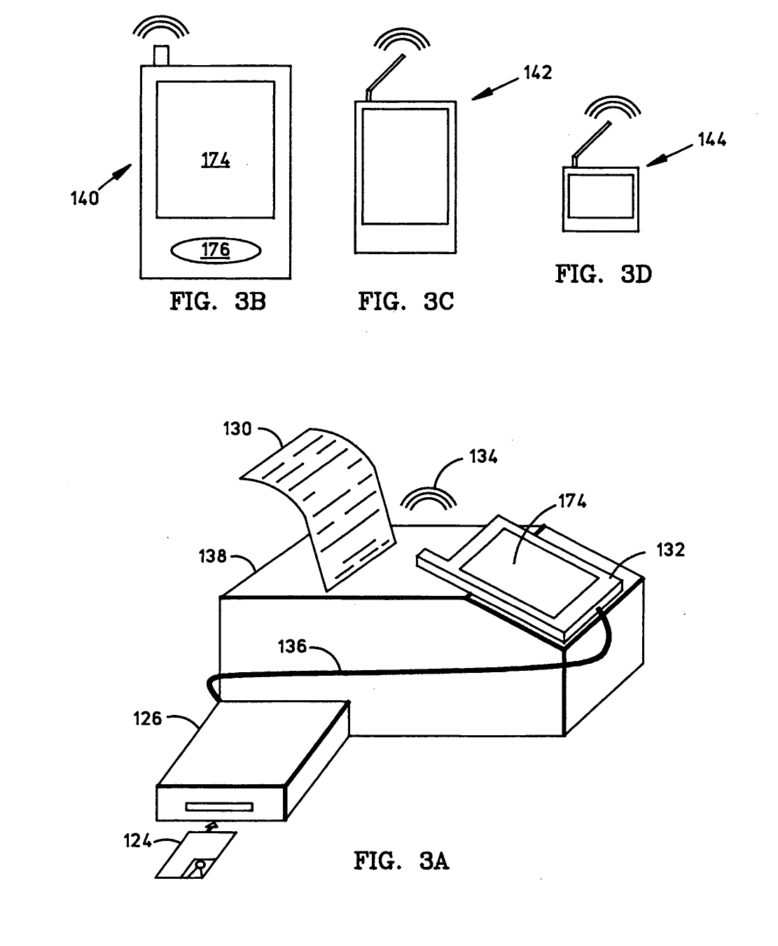

Importantly, after completion of the order verification and payment authorization procedures, Business Engine Logic 26 finally transmits the ordering information to the merchant through an order data link 66 to the Merchant In-Store POS System 34. Link 66 is preferably embodied as a dynamic Internet connection employing a sockets call over TCP/IP. Merchant In-Store POS System 34 is discussed in more detail below in connection with FIGS. 3-4.

The Ordering Process:

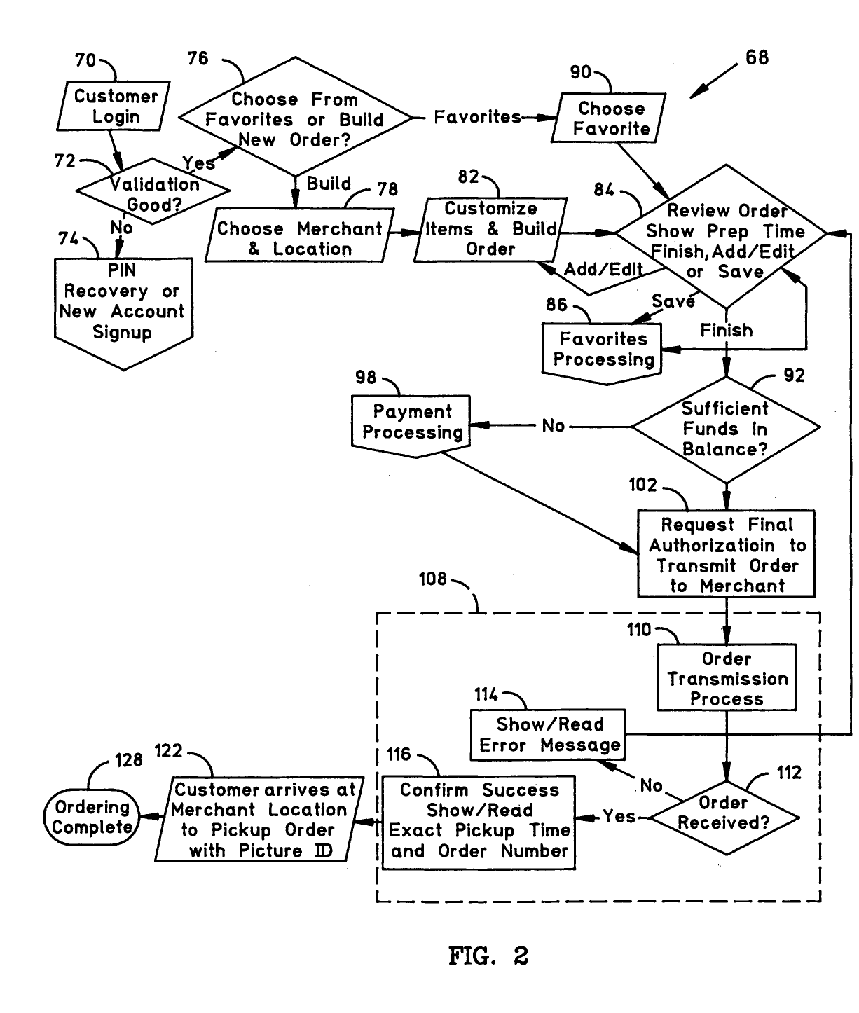

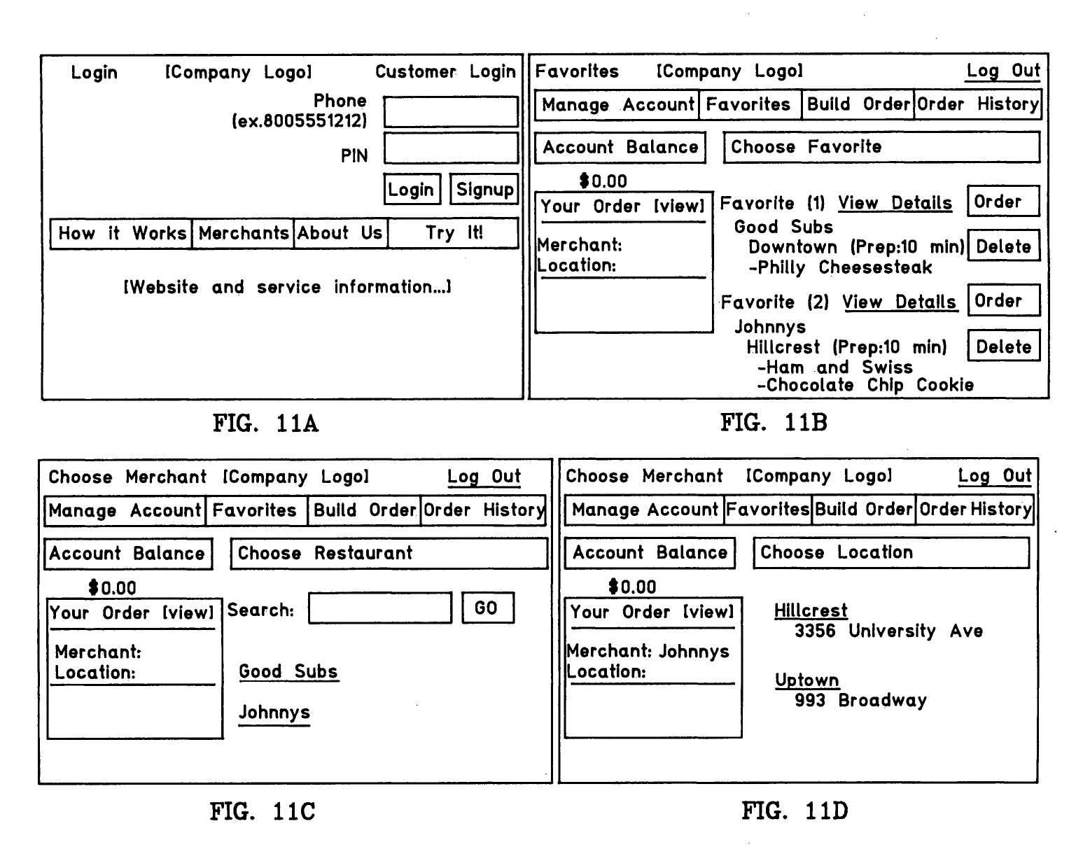

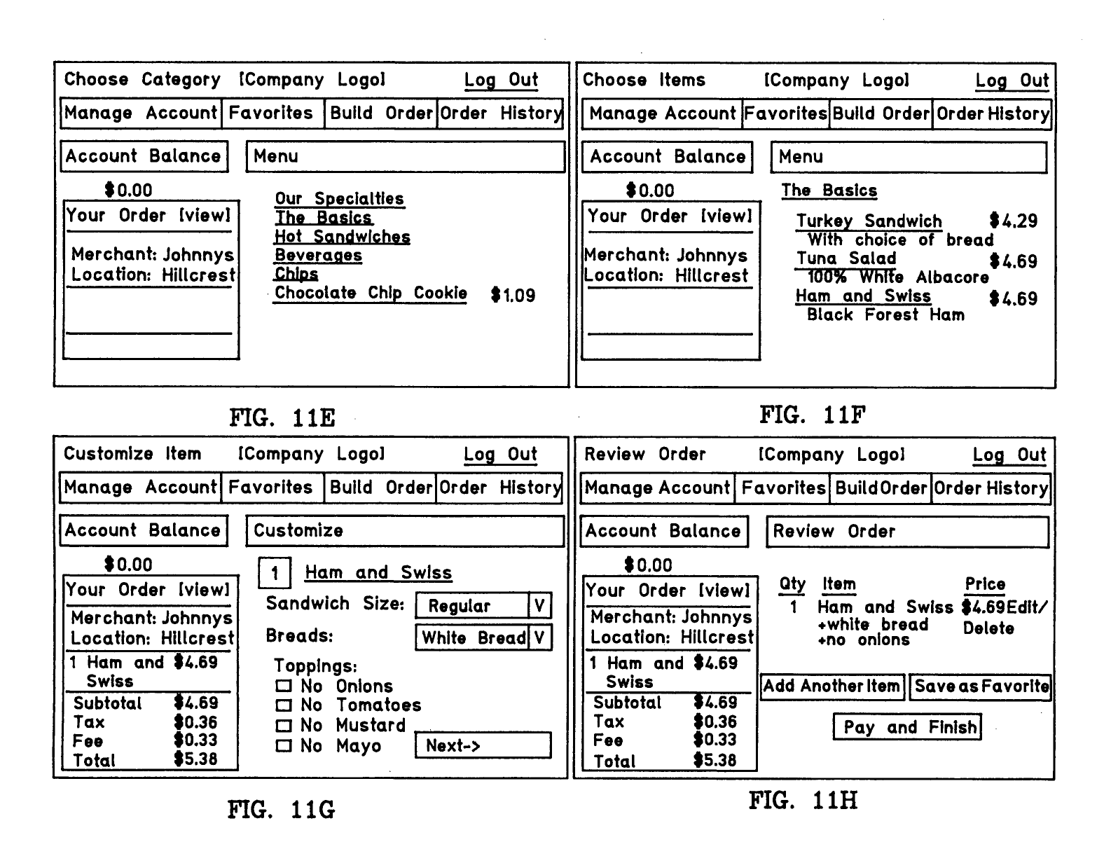

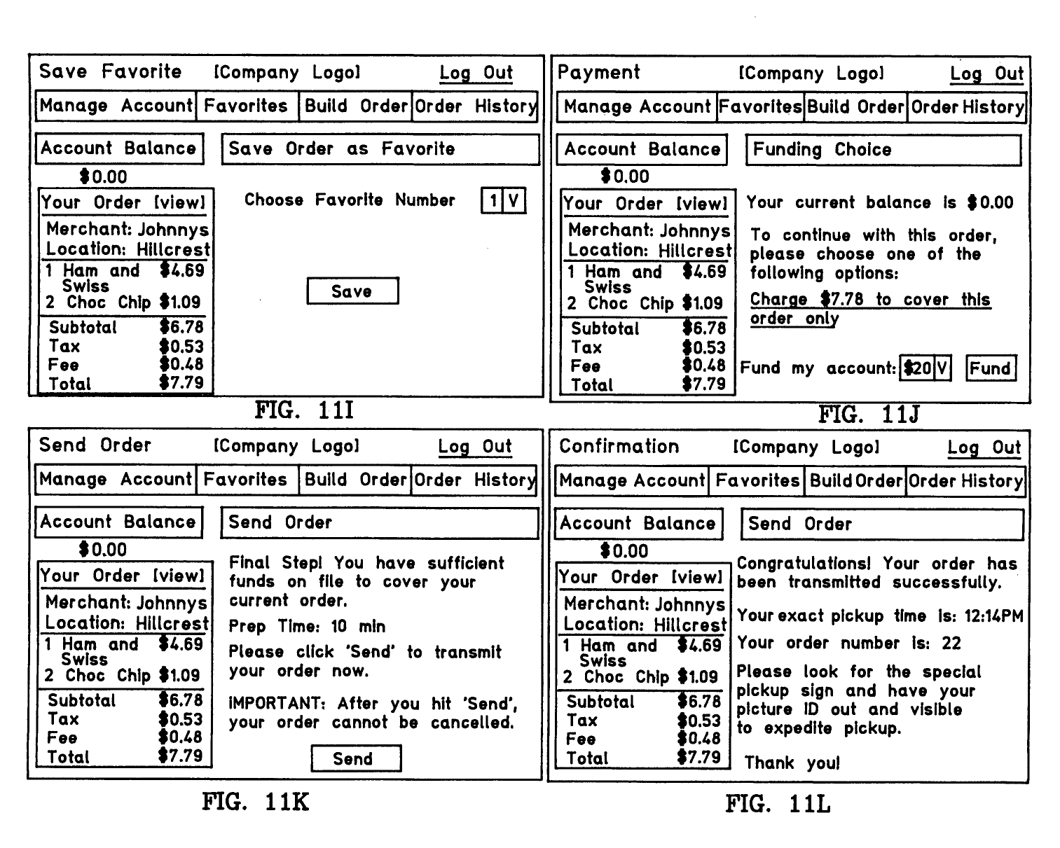

FIG. 2 illustrates the food order fulfillment method 68 of this invention. The user initiates the ordering process at the first step 70 by logging into system 20 by means of, for example, an Internet connection to a web-based GUI display such as the GUI display represented in FIG. 11 A. Preferably, the user account number is the user phone number so that caller-ID data may be used to accelerate user login when logging on by alternative means such as, for example, a telephone connection to an interactive voice response (IVR) system (not shown). As used herein, every form of the verb “display” denominates all useful means for communicating data to the user, including by means of a GUI display, by means of an audio voice response message, by means of a simple text message in any form or by means of any other similarly useful means for communicating data to a user. The user is prompted to enter a personal identification number (PIN) and, in the next step 72, this PIN together with the user account number is used to validate the requested access and to log in. If step 72 fails, or no account exists, the step 74 is next performed to prompt for a new account signup option and a PIN recovery request option. If step 72 succeeds, the user is logged into system 20 and prompted with the options of either reordering a previously configured order (a “favorite”) or building a new order in the next step 76 by means of, for example, the GUI display represented in FIG. 11B.

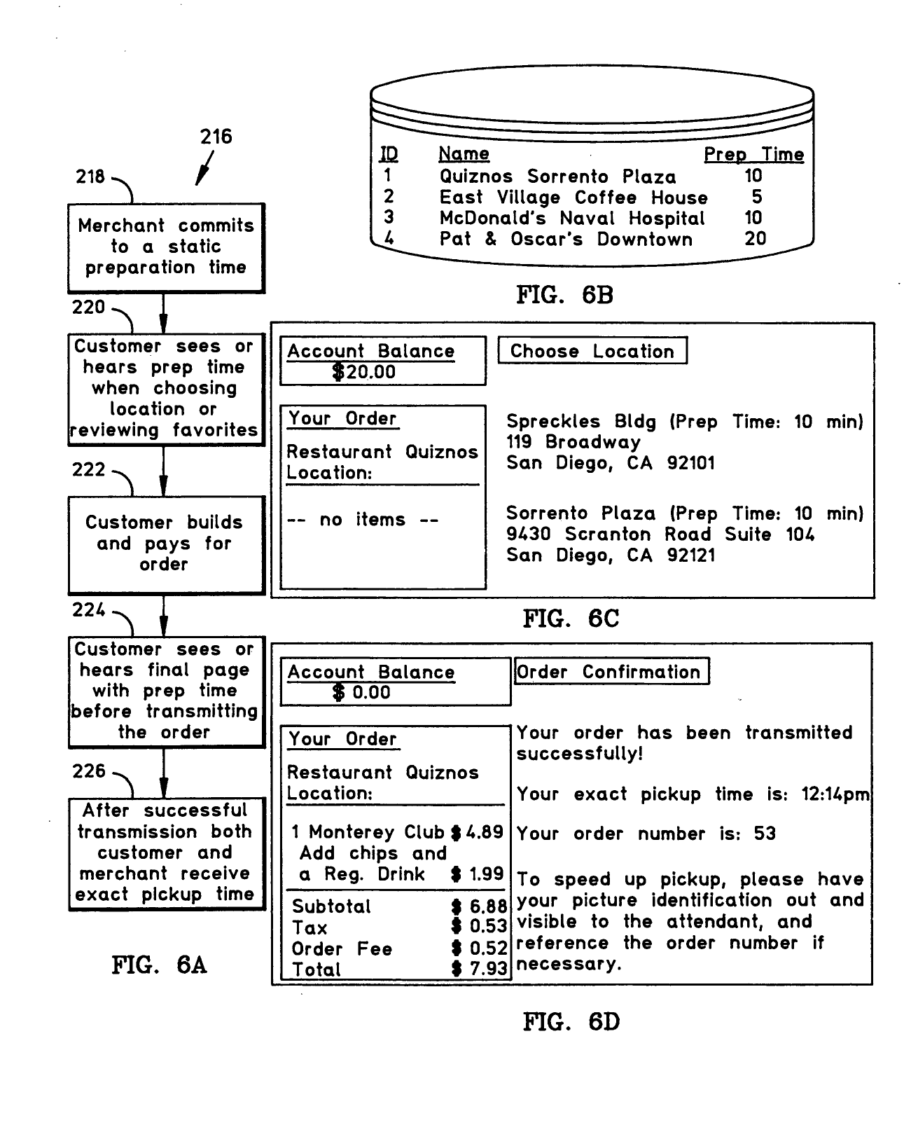

When the user chooses to build a new order at step 76, the process proceeds to the step 78 where the user is prompted to select a merchant by means of, for example, the GUI display represented in FIG. 11C and then prompted to select a location associated with the selected merchant by means of, for example, the GUI display represented in FIG. 11D. During step 78, the user may be provided with various tools (not shown), such as, for example, means for searching for a merchant by name and means for requesting a listing of merchants by zip code or other geographical region. As exemplified in FIG. 11D, a “prep time” field 80 is displayed with each of the locations listed for the selected merchant. Prep time field 80 represents the static preparation time in minutes established by the merchant for each location and is used by the merchant to schedule the completion of the order and by the user to schedule arrival for pickup. The utility of this “prep time” element of the system of this invention is discussed in more detail below in connection with FIGS. 6A-D.

Having evaluated locations and prep times for the selected merchant in step 78, and having selected a location, the user is first prompted in the next step 82 to select from a list of product categories for that location by means of, for example the GUI display represented in FIG. 11E. This product category list is generated dynamically from merchant data 44 (FIG. 1). In step 82, having made a product category selection, the user is then prompted to select from a list of items within the selected category by means of, for example the GUI display represented in FIG. 11F. In step 82, having made an item selection, the user is finally prompted to select from a list of customization options for the selected item by means of, for example the GUI display represented in FIG. 11G, thereby completing the user specification of the particular food order item. Having been completely specified, the customized item is added to the order and, in the next step 84, the user is prompted to review the entire food order by means of, for example the GUI display represented in FIG. 11H. As illustrated in FIG. 11H, step 84 affords various user-selectable options such as, for example, adding another item to the order, editing a selected item or deleting an existing item from the order, saving the order as a “favorite” to make it available for reorder in future, and proceeding to payment by finishing the order. In step 84, when the user chooses to save the customized order as a favorite, the process moves to the step 86 wherein the user is prompted to supply a “favorite reference” number 88 by means of, for example the GUI display represented in FIG. 11I. If number 88 entered by the user represents a previously-saved favorite order, the user is prompted to either overwrite the existing favorite or choose a new number.

When the user chooses to select an existing favorite order at step 76, the process proceeds to the step 90 where the user is prompted to select from a listing of previously-designated favorites displayed together with the associated prep times for each of the associated locations for the selected merchant by means of, for example, a GUI display similar to that represented in FIG. 11B.

Upon completion of step 84, when the user has finished building, configuring and saving the current order, the user is prompted by the next step 92 for payment by means of, for example the GUI display represented in FIG. 11J. Step 92 first compares a total order price 94 against an existing user account balance 96. If total order price 94 exceeds existing user account balance 96, the user is prompted in the next step 98 to provide the additional funds necessary to cover total order price 94 by means of, for example, a funding selection 100 (FIG. 11J). Accepting and authorizing payment by means of Internet connections is a well-known in the art, and many useful means for doing so may be readily appreciated by any practitioner skilled in the art. When step 98 or step 92 completes successfully, the user is prompted to provide final authorization for payment in the next step 102 and the order is transmitted to the merchant for the first time. If neither of steps 98 or 92 complete successfully, the user cannot complete the order. This mandatory prepayment step is an important element of the method of this invention.

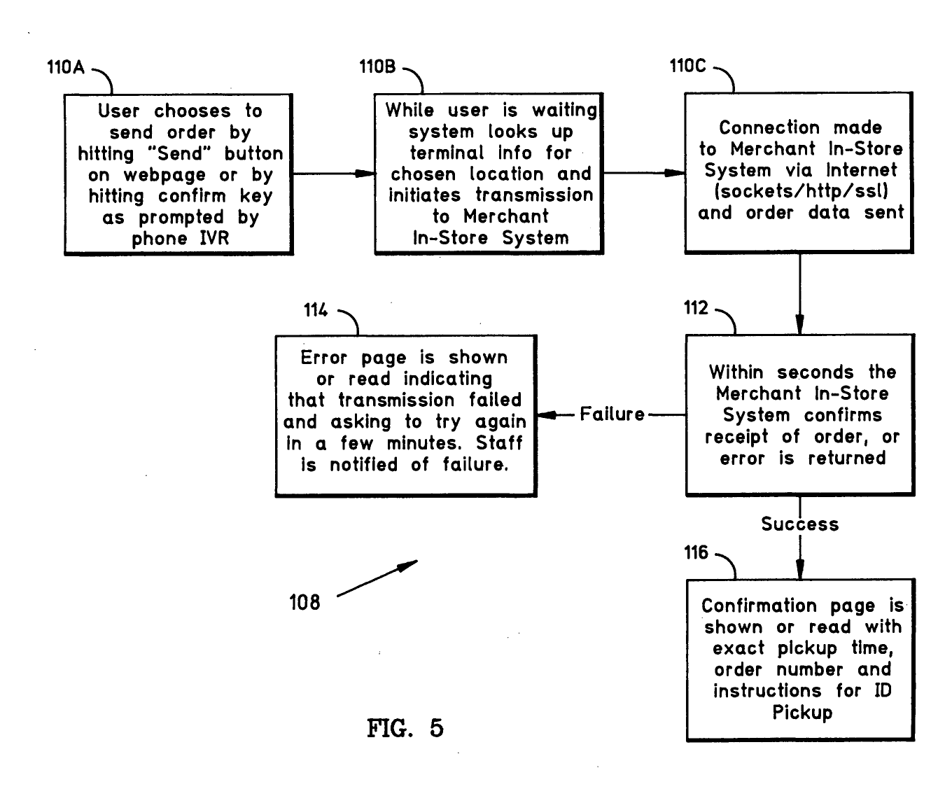

During step 102, the user is reminded of the exact prep time 104 (FIG. 11K) associated with the order to permit the user to schedule order placement (transmission) so that arrival for pickup can occur immediately upon completion of order preparation. Once the user finally authorizes order payment by means of, for example, a ‘Send’ button 106 (FIG. 11K) or an appropriate key on a telephone keypad, the order transmission process 108 is initiated at the step 110 (FIGS. 2 and 5). Order transmission process 108 is carried out in a few seconds while the user waits to receive confirmation. By means of, for example, the Internet or the local telephone system, without limitation, a data connection is established to the associated Merchant In-Store POS System (system 34 in FIG. 1) and the order data are transmitted. Following the order transmission to the merchant in step 110, a confirmation of receipt or error is returned to the user in a few seconds in the following manner. The next step 112 tests the order transmission of step 110 for success or failure. If step 110 returns an error, step 112 branches to the step 114, which prompts the user to resubmit the order later and also sends email and pager alerts to technical staff to permit immediate steps to bring the affected Merchant In-store POS System back online. If step 110 returns a success code, step 112 branches to the step 116, which informs the user of final order confirmation by means of, for example, the GUI display illustrated in FIG. 11L. Such final order confirmation data includes, without limitation, the exact pickup time 118 to which the merchant is committed (this is also the order completion time and may represent, for example, the transmission time plus the associated static prep time) and an order number 120. This exact pickup time process is discussed in more detail below in connection with FIGS. 6A-D.

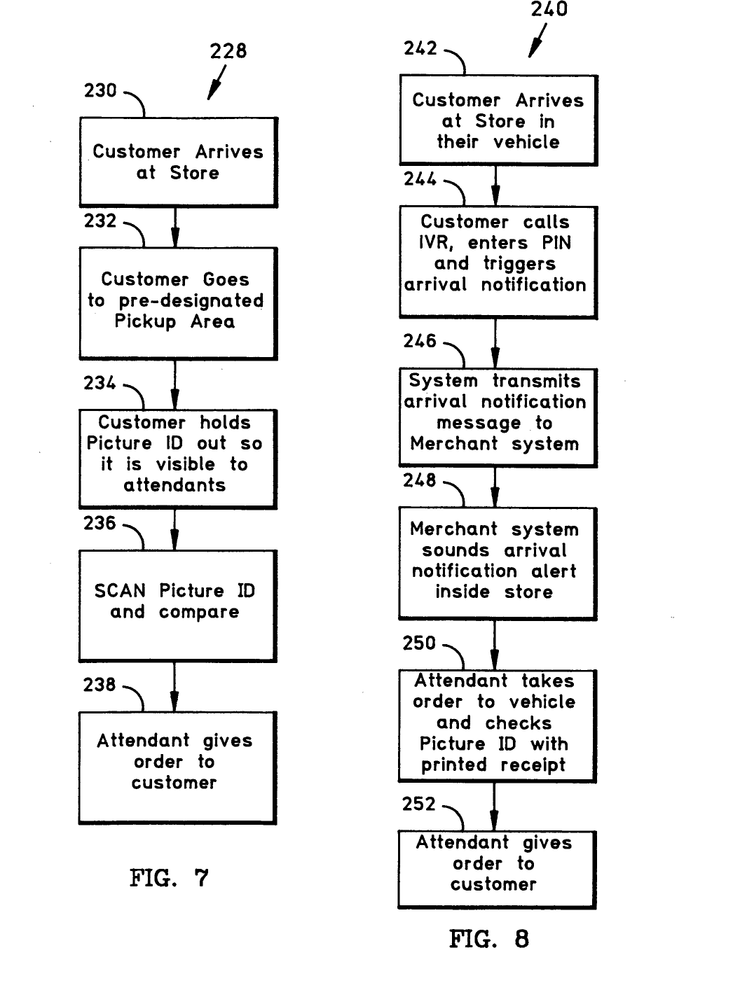

After completion of method 108 at step 116, the next step 122 (FIG. 2) is initiated when the user arrives at the location Pickup Area, which may be marked by a special sign, for example. In one embodiment, step 122 includes the ID Pickup process (FIG. 7) during which the user walks in and presents some useful form of user identification (ID) for confirmation of user identity. For example, the user may present a picture ID 124 to a scanning device 126 (FIG. 3A) to inform the attendants that the walk-in user is actually a pre-order user who is picking up a completed food order. Any useful method for confirmation of user identity by means of a user ID may be employed in step 122. For example, the attendant may complete order fulfillment at the final step 128 responsive to a successful comparison of the user identity with a receipt 130 (FIG. 3A) printed by Merchant In-Store POS System 34. The ID pickup process embodiment of step 122 is an important element of the method of this invention and is described in more detail below in connection with FIG. 7.

The Real-Time Order Confirmation Methods:

FIG. 5 illustrates real-time order transmission process 108 (FIG. 2) in more detail. Importantly, process 108 operates to confirm to the user that the merchant has actually received the food order in the physical store where the user plans to accept delivery (order fulfillment) at a specific pickup time. As described above in connection with FIG. 2, process 108 employs bidirectional data transmission between Business Logic Engine 26 and Merchant In-Store POS System 34 in real time.

Referring to FIG. 5, in the step 110A, after a user has configured and paid for their order (FIG. 2), the user is prompted to submit final confirmation, which operates to transmit digital data representing the food order to the merchant restaurant. Step 110A may be accomplished, for example, by clicking on a GUI ‘Send’ button displayed in the web ordering GUI or by depressing a telephone key while connected to a IVR ordering system interface. As used herein, the term “real-time” denominates a process that returns a message indicating the success or failure of the order transmission within an interval sufficiently short to permit the user to reasonably await the result before terminating the connection with the appropriate one of user interfaces 22.

In the next step 110B, food order fulfillment system 20 retrieves the relevant connection and link data necessary for establishing an Internet connection to Merchant In-Store POS System 34 located in the user-selected merchant location. Preferably, the information includes a fixed IP address assigned by the wireless carrier to radio modem 134 in POS System 34. In the next step 110C, using, for example, the retrieved IP address with the TCP/IP, Business Logic Engine 26 requests a sockets connection to the appropriate port of Merchant In-Store POS System34. If the requested sockets connection is successfully established, the food order data is transmitted in the form of, for example, a URL-encoded and encrypted text string. Alternatively, the relevant connection and link data to the appropriate Merchant In-Store POS System 34 may include a hostname or private address assigned by a proxy or virtual private network (VPN), for example. Within seconds, in step 112, Business Logic Engine 26 receives a confirmation message back from Merchant In-Store POS System 34 showing either that the food order data was transmitted successfully (proceeding to step 116) or that the transmission process terminated with an error (proceeding to step 114). As described above in connection with FIG. 2, in step 114, the user is delivered a message (via GUI or audio, for example) confirming the transmission failure and prompting for a retry. This is advantageous to the exact pickup time method of this invention because the user is permitted to place an order a few minutes before arriving to pickup the order without risk of unknown order failure. In step 116, the user is delivered a message including the final order confirmation, including an exact pickup time and an order number, for example, and this confirmation may also include instructions for expediting the pickup (fulfillment) at the restaurant.

The Merchant In-Store POS System Hardware:

FIGS. 3A-D illustrate several useful hardware embodiments ofthe deployed in-store Point-Of-Sale (POS) system 34. In the embodiment shown in FIG. 3A, POS System 34 includes a compact computer 132 with a connection by a wireless modem 134 to the Internet and a connection by a cable 136 to a receipt printer 138. POS System 34 is universal in that it may be installed and ready for use by any merchant by simply plugging it into a power outlet because any necessary POS system configurations, including the provisioning and configuring of the data service with the wireless carrier, can be completed remotely before installation at the store. This is a significant advantage of the system of this invention because of the reduction in the cost of new store installations and the ease and speed with which a merchant can begin using the service.

Preferably, computer 132 is a handheld computer or personal digital assistant (PDA) such as the PDA 140 shown in FIG. 3B, but computer 132 may alternatively include any useful general purpose computer having one or more central processing units (CPUs), data memory, external data ports, speaker, display and user interface means (e.g., touchscreen, buttons or keys). The preferred device is an HP/Compaq IPAQ 3600 series, as it's inexpensive, widely available and easily to expand. This device when used with it's PCMCIA expansion pack can support any number of PC Card cellular modems, which is the most widely available and supported of the three most common types of cellular modems (PC Card, Embedded or CF Card).

Computer 132 preferably includes an associated Microsoft Operating System (OS); for example, PDA 140 includes the Microsoft Pocket PC 2002 OS (not shown). Such an OS is usually included with the many useful devices suitable for use in computer 132 and is sufficiently popular to include many supported libraries and developer tools for advanced functionality. Other OSs for specialized compact devices may also be used, such as the Palm OS, Symbian and Linux. Computer 132 may alternatively rely on customized application code without any general OS developed and compiled using tools such as Microsoft Visual C#, .NET for the Compact Framework or Java 2 Micro Edition (J2ME), for example.

Preferably, POS System 34 is connected to the Business Logic Engine 26 (FIG. 1) by means of the Internet, thereby enabling real-time transmission and confirmation of food orders from users and real-time updating by merchants of product data 42 and merchant data 44. Because of the universality of wireless cell phone connections, the preferred embodiment of wireless modem 134 for connecting the Internet is a radio modem, herein also denominated a cellular modem. In the embodiment illustrated in FIG. 3C, wireless modem 134 includes a PC Card type radio modem 142, which may include, for example, a Sierra Aircard 555 PC Card modem, or any other useful PC Card radio modems known in the art. PC Card modem 142 is inexpensive and universally supported and is commonly used to connect laptops and PDAs to the Internet over a cellular network. Other useful PC Card modems include the Merlin series by Novatel or the private label brands provided by carriers such as the Verizon EVDO, for example. Other useful radio modems include the embedded type, such as used with the Samsung SPH-i700 or HP IPAQ h6315 and the CompactFlash type modem 144 (FIG. 3D) such as the Sprint 1×RTT CompactFlash Modem, for example. A key advantage of the system of this invention is the connection of POS System 34 to the Internet by means of a wireless radio modem. The alternatives of, for example, using a merchant's existing Internet connection or provisioning a new DSL or cable data service, prevent accomplishment of all necessary provisioning and configuring before the in-store installation and preclude most self-installations and remote installations of POS System 34. Also, through the use of “telemetry” service plans available from many of the wireless telecommunication providers, the cost of the Internet connection can be as much as one tenth the price of the wired equivalent. Preferably, modem 134 includes a Sierra Aircard 555 for connection to the Internet over a Verizon CDMA network. However, carriers supporting the GSM/GPRS network standard (such as AT&T or T-Mobile) or other CDMA carriers (such as Sprint) are also suitable and, when combined, offer coverage over most of the cities in the industrialized world.

Receipt printer 136 operates to print at least one detailed receipt 130 for each food order, and should also be able to print various reports (not shown) for the merchant. Preferably, Receipt printer 136 includes an Epson TM88 serial receipt printer with auto-cutter but any other useful thermal or dot matrix receipt printers may alternatively be used, including those that support the Bluetooth standard and those that may embedded in a handheld computer embodiment of computer 132.

Communication between computer 132 and receipt printer 134 may occur over any useful serial data connection. For example, the serial sync cable provided for PDA 140 (e.g., an IPAQ handheld computer) may be adapted to connect to the standard 25-pin serial connector on receipt printer 138. This computer-printer data link may alternatively be embodied as, for example, a WiFi, bluetooth or infrared channel where appropriate.

The Merchant In-Store POS System Software:

FIG. 4 illustrates a useful embodiment of the POS system software class library 146, which includes the specialized classes for coordinating the operation of hardware components of Merchant In-Store POS system 34 and the Internet communication with Business Logic Engine 26. Preferably, POS system software class library 146 includes application classes written in a suitable high-level object-oriented framework, such as, for example, Microsoft Visual Basic or Visual C# on Compact Framework. Such a suitable framework allows the straight forward development, without undue experimentation, by any skilled practitioner of the necessary graphical user interface and, for example, the GUI Manager class 148 in accordance with the detailed functional description presented below. With GUI Manager class 148, any skilled practitioner may then, without undue experimentation, develop the other necessary POS system classes based on the detailed interface and functional descriptions presented below. Such classes may include, for example, an Order Manager class 150, a Notification Manager class 152, a Print Manager class 154, a Preferences Manager class 156 and a Menu Manager class 158 to display associated data and reports to the merchant staff and management. One or more objects representing instances of these classes operate to accept and process data and manage communications linkages with other system elements such as, for example, a Web Server class 160, a Connection Manager class 162, a HTTP Client class 164, an XML Parser class 166, a Task Scheduler class 168, a Time Sync Client class 170 and a Database Management System 172.

Referring to FIG. 4, GUI Manager class 148 includes the methods and data needed to display, for example, order information, alert notifications, configuration options for printing and general preferences, and menu management features. GUI Manager class 148 preferably includes methods incorporating certain functions of the PocketPC operating system to create a “kiosk mode”, whereby only the functions and screens applicable to Merchant In-Store POS System 34 are available. This kiosk mode is an important feature of the system of this invention because it makes feasible the “universal” character of POS system 34 and is key to the feasible embodiment of POS system 34 as a common electronic device such as PDA140 (FIG. 3B) or handheld computer 132 (FIG. 3A). This is because the kiosk mode prevents merchant staff from playing with other standard consumer features of handheld computer 132 and thereby avoids performance problems and unwanted distractions. GUI Manager class 148 calls the appropriate standard commercial framework classes to instantiate objects representing various buttons, screens, navigation tools and input objects allowing users to view, edit and print the information needed to interface with POS system 34. Preferably, GUI Manager class 148 includes methods for generating views of, for example, an order list, a single order, an alerts window, a connection status, various preferences pages, a passcode entry page and various menu management pages. Each of these pages may require instantiation of other classes from POS library 146, as may be appreciated with reference to the following discussion.

Each instance of Order Manager class 150 provides an instance of GUI Manager class 148 with the data required to generate the orders list and single over view. The orders list should be configured to allow merchant staff to quickly view several orders at once and to view the most important information for each order, which may include, for example, the exact pickup time, the user name, the major items in the order, the order number and the state of the order. Staff should be afforded means for then selecting any of the orders in the list to view in full detail, formatted on the touchscreen 174 as it is printed on receipt 130 (FIG. 3A). Such single order view should include GUI buttons to cancel, edit, re-print or update the order status and to indicate order completion and delivery (fulfillment). Order Manager class 150 includes methods that accept from an instance of Web Server class 160 any incoming orders posted remotely by Business Logic Engine 26 (FIG. 1). Order data is then updated in a local instance of Database Management System 172, which keeps a local order data file current and purged of completed orders in cooperation with regularly scheduled actions triggered by an instance of Task Scheduler class 168. When an order arrives, it is sent to an instance of Print Manager class 154 to be printed immediately in hard copy as receipt 130, and then methods within an instance of Notification Manager class 152 are executed to give audible and visual alerts to in-store staff of the new order or an arriving curb-side user. Order Manager class 150 also includes methods for generating useful reports from a local instance of Database Management System 172. These reports may, for example, be viewed or printed, and may include data summaries such as daily and weekly totals, average ticket size and fee summaries, for example.

Continuing with FIG. 4, Notification Manager class 152 includes methods for notifying an instance of GUI Manager class 148 of events such as, for example, new order arrivals, curbside user arrivals and system errors. Notification Manager class 152 also includes methods for alerting staff of important events by means of, for example, audible alerts through a speaker system 176 (FIG. 3B) of Merchant In-Store POS System 34, which is a preferred embodiment of compact computer 132. Such audible staff alerts to new orders or arriving users are very important, so the associated methods of Notification Manager class 152 should require affirmative staff acknowledgment before quitting. For example, should a staff member fail to tap a big GUI button on touchscreen 174 to acknowledge an alert, Notification Manager class 152 methods should trigger the alert repeatedly on a regular interval (e.g., every 20 seconds) until acknowledged. Notification Manager class 152 methods also cooperate with instances of GUI Manager class 148 to display a connection status page (not shown) that shows the necessary states and notifications generated by a local instance of Connection Manager class 162, thereby ensuring that merchant staff are timely notified of any problems with the Internet connection or radio modem reception.

Print Manager class 154 includes methods that respond to events from instances of Order Manager class 150 to print detailed receipts of individual orders, as well as summary reports for managers, for example. These methods operate to maintain a connection with receipt printer 138 (FIG. 3A), which preferably is a standard serial connection, but may also be embodied as a Bluetooth, infrared or WiFi connection, with the assistance of the appropriate well-known connection classes. Print Manager class 154 also includes methods for communicating print data with receipt printer 138, either directly by means of ESC/POS commands to the printer or by means of a printer driver object, and which preferably also provides appropriate line feeds and auto-cut commands. Certain options may be selected for the methods of Print Manager class 154 through the GUI methods of a local instance of Preferences Manager class 156. For example, the number of copies of receipt 130 printed for each incoming order may be selected; many restaurant merchants prefer to print duplicates or triplicates for record keeping purposes and/or to facilitate communication with their kitchens.

Continuing with FIG. 4, Preferences Manager class 156 includes methods for storing and retrieving various optional configurations selected by merchant and staff, which call on methods of GUI Manager class 148 to generate preference page views. Preferences such as how many receipt copies to print, configuration options for order list and single order displays, and speaker volume are managed by an instance of this class, which may store some settings in a local instance of Database Management System 172 and other settings in dedicated configuration files, for example. Preferences Manager class 156 also includes methods for managing passcode authentication and access to areas and functions restricted to merchant management.

Menu Manager class 158 includes methods for displaying menu information to the merchant through the menu administration pages (not shown) generated by methods of GUI Manager class 148. The menu administration pages should be embodied to permit viewing and modification of local menu data, and may also request synchronization of local menu data with Product Data 42 and Merchant Data 44 by way of Internet communications with Business Logic Engine 26 (FIG. 1) using calls to appropriate methods of a local instance of HTTP client class 164. For example, a merchant may mark a menu item as temporarily unavailable or as restocked, or may modify prices and menu item options available to remote users. Preferably, such communications are conducted using methods of HTTP client class 164 to transfer hierarchical menu data in XML format. Such XML data are processed by methods of a local instance of XML Parser class 166 and updated in a local instance of Database Management System 172 from where they may be displayed as desired in the menu administration pages.

An instance of Web Server class 160 is connected to the Internet through an instance of Connection Manager class 162 to handle all incoming transmissions from Business Logic Engine 26 of order data and other events. Preferably, an asynchronous sockets server object is used to listen for incoming Internet connection requests and, when detected, to handle session authentication with Business Logic Engine 26 before accepting transmitted data. In one embodiment, the order data may be transmitted as an encrypted URL-encoded text string, for example, which the Web Server class 160 object then decrypt and passes along to an Order Manager class 150 object. Web Server class 160 also includes methods for responding to monitoring “pings” from Business Logic Engine 26to maintain the Internet connection. Alternatively, Web Server class 160 may incorporate and use web services provided by the local operating system or other third party vendors to handle HTTP requests and SSL transmissions, or even a full SOAP server, permitting Web Server 24 to post the food orders in XML format and request XML data from POS system database 172. Such alternative embodiments may be more advantageous with decreasing wireless carrier bandwidth cost and improved memory and processor hardware.

Continuing with FIG. 4, Connection Manager class 162 includes methods for establishing and maintaining an Internet connection by way of radio modem 134, which is the primary communication link between Merchant In-Store POS System 34 and Business Logic Engine 26. Connection Manager class 162 includes methods for transferring important changes in the modem or wireless network states to an instance of Notification Manager class 152 for display on the connection status page (not shown). Connection Manager class 162 also includes methods for regularly checking on the health of radio modem 134 and the Internet connection (order data link 66 in FIG. 1) in cooperation with an instance of Task Scheduler class 168, and includes methods for rebooting the entire system to reset modem firmware and refresh the Internet connection when appropriate. Preferably, Connection Manager class 162 incorporates the Microsoft Pocket PC Remote Access Service (RAS) and Connection Manager. Through the methods of Connection Manager class 162, an Internet connection may be opened, notices of poor signal strength or network failure may be received, and connections terminated when appropriate. The associated events may also be logged for troubleshooting purposes. Alternatively, Connection Manager class 162 may include classes and methods from vendor-supplied class libraries for radio modem 134, which is preferred for embodiments of modem 134 that do not comply with operating system specifications.

HTTP client class 164 includes methods for initiating outgoing Internet connections to Business Logic Engine 26 and other services such as those desired for time synchronization. These methods include the well-known hypertext transfer protocol (HTTP) for connecting to remote servers, for requesting specific data, and for returning the contents to the requesting agent, such as an instance of Menu Manager class 158 during a menu synchronization process or an instance of Time Sync Client class 170 when synchronizing the operating system time clock. Preferably, HTTP client class 164 includes classes and methods from the Microsoft Compact Framework libraries. Because the returned data is often in XML format, the requesting agents require access to exposed methods of XML Parser class 166 to simplify handling of the hierarchical data.

XML Parser class 166 includes methods for the manipulation of and recursive operations with hierarchical XML data responsive to events from requesting agents such as instances of Menu Manager class 158. Preferably, XML Parser class 166 includes classes and methods from the Document Object Model (DOM) libraries included in the Microsoft Compact Framework for parsing and manipulating XML data.

Continuing with FIG. 4, Task Scheduler class 168 includes methods for initiating calls to other class instances responsive to a specific time or interval elapse. For example, an instance of Task Scheduler class 168 may be used to schedule periodic review of Internet connection status through an instance of Connection Manager class 162 or to schedule local system time clock updates through an instance of Time Sync Client class 170. Such an instance of Task Scheduler class 168 may also be used by an instance of Notification Manager class 152 to help replay key audio alerts when unacknowledged by merchant staff. Order Manager class 150 includes methods for calling Task Scheduler class 168 to conduct the periodic database purges required to conserve limited memory space, or the periodic system restarts needed to overcome the effects of slow memory leaks and attenuated Internet connections, for example.

An instance of Time Sync Client class 170 is important for the proper synchronization of food order completion with remote user arrival because it operates to ensure that the local time clock of Merchant In-Store POS System 34 is synchronous with the system time clock administered in Business Logic Engine 26 to serve the various user interfaces 22. As one example, Time Sync Client class 170 may include network time protocol (NTP) methods to access any suitable public NTP server and for updating the local system time clock responsive thereto. The same class and methods may be used in the software portion of Business Logic Engine 26 to ensure that the time clocks in systems 34 and 26 are always synchronous to within a second or so. Time Sync Client class 170 also includes methods for sending the local system time to an instance of GUI Manager class 148, which includes methods for displaying this time on various GUI displays, to permit merchant staff to compare the pickup time with the current system time, thereby avoiding problems arising from erroneous in-store clocks and watches.

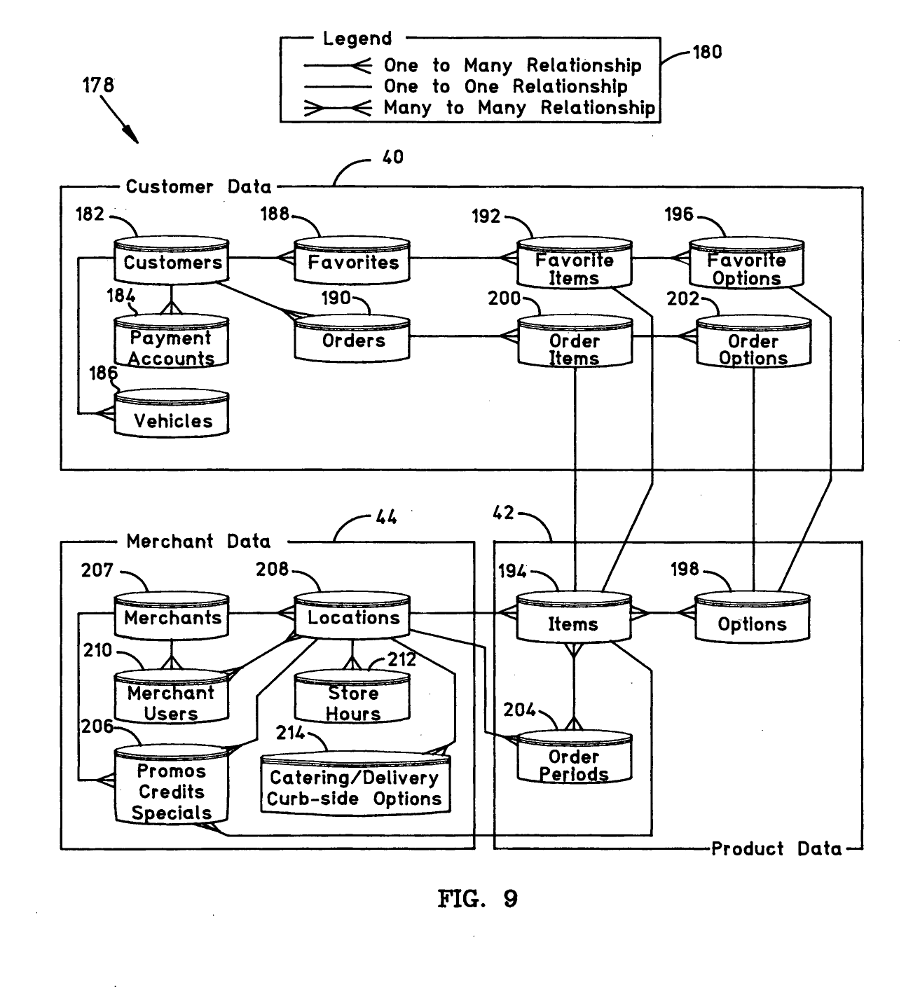

Database Management System 172 includes one or more database manager classes and a database structure stored in memory, with methods for accepting database queries formatted in Structured Query Language (SQL), for example. Preferably, Database Management System 172 includes classes and methods from Microsoft SQL Server CE, but any other relational database management system (RDBMS) useful with handheld computer embodiments of compact computer 132 may alternatively be included, such as Visual CE, PointBase or CloudBase, for example. A local instance of Database Management System 172 is used by Order Manager class 150, Menu Manager class 158 and Preferences Manager class 156 to read and write relevant data. Each instance of Database Management System 172 in Merchant In-Store POS System 34 uses the same food order and menu data relationships as those used by Business Logic Engine 26 from database 38 (FIG. 1). These data relationships are now discussed in connection with FIG. 9.

The Entity Relationship Diagram:

FIG. 9 provides an entity relationship diagram (ERD) 178 illustrating a useful embodiment of the user, merchant and product data structures for systems 26 and 34. ERD 178 represents the major groups of data and database tables employed by POS System 34 and Business Logic Engine 26 to perform food order fulfillment method 68 of this invention (FIG. 2). ERD 178 is interpreted in accordance with the legend 180 and includes customer data 40, merchant data 44 and product data 42 from database 38 (FIG. 1). Although practitioners in the database arts may quickly appreciate the format of ERD 178 and legend 180, some illustrative and exemplary discussion is now provided.

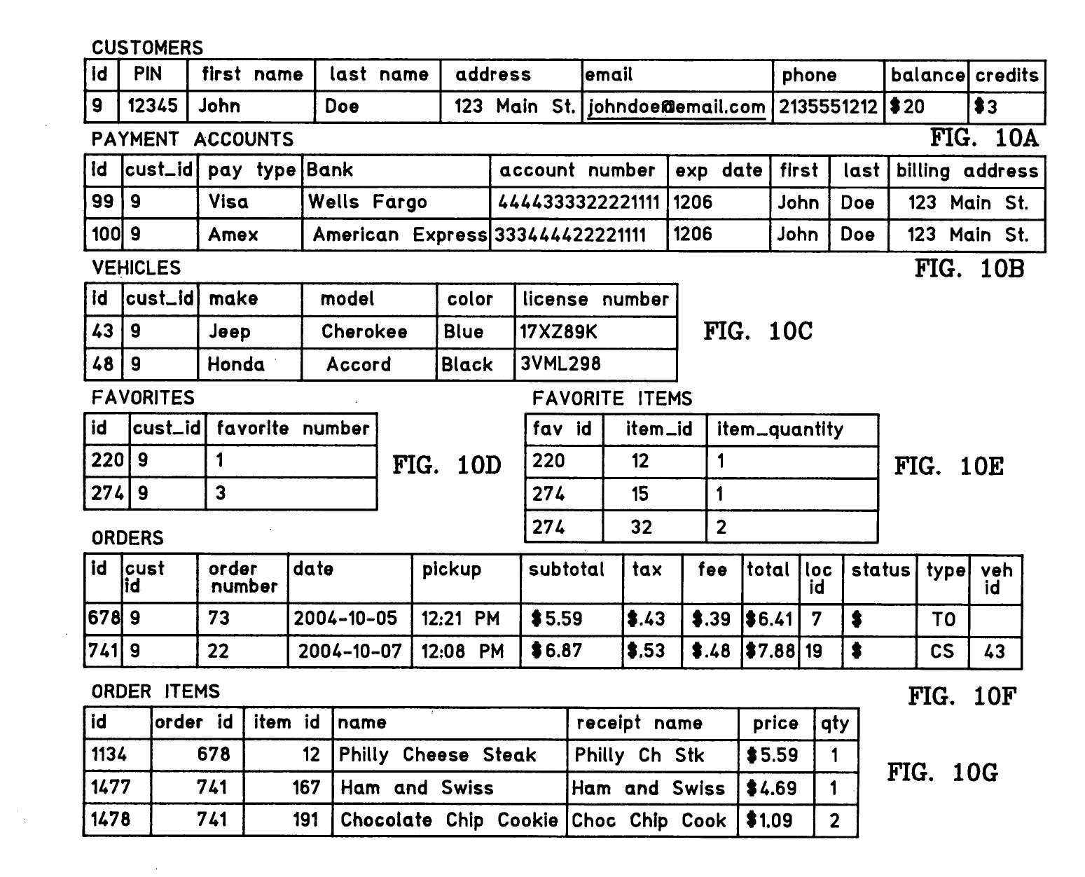

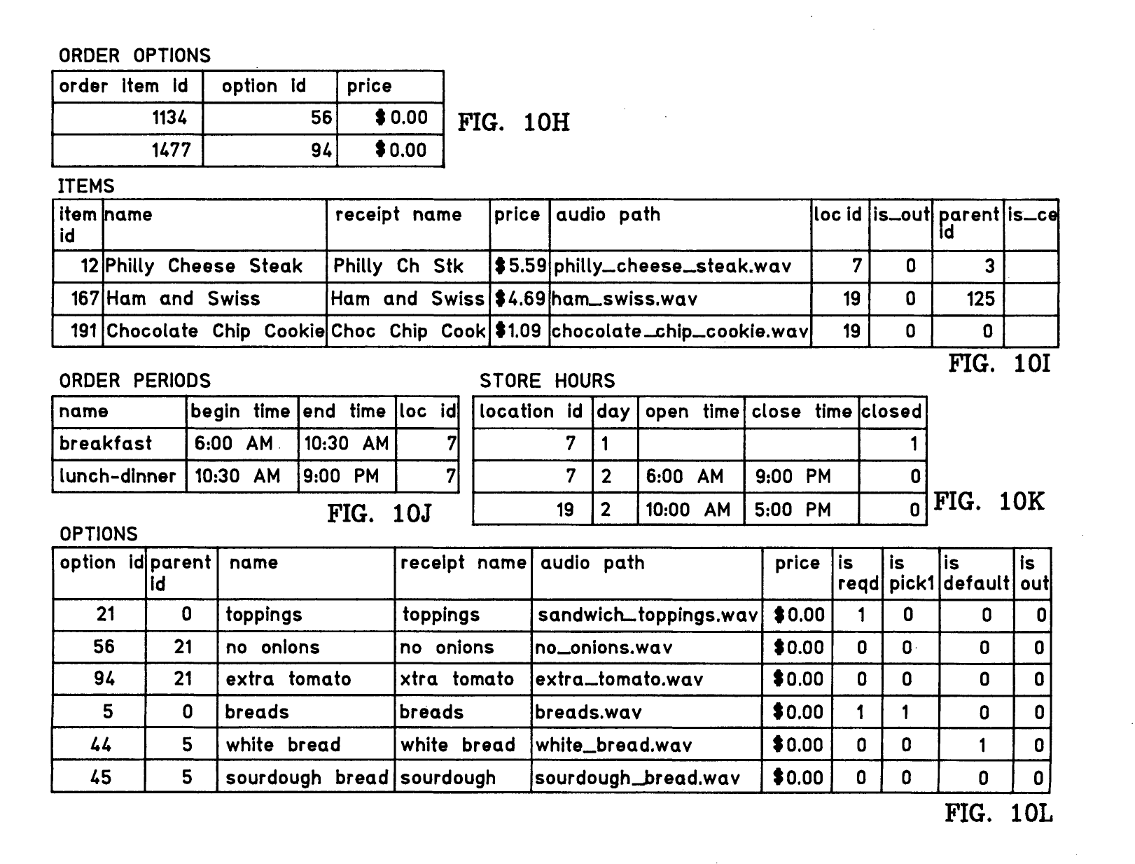

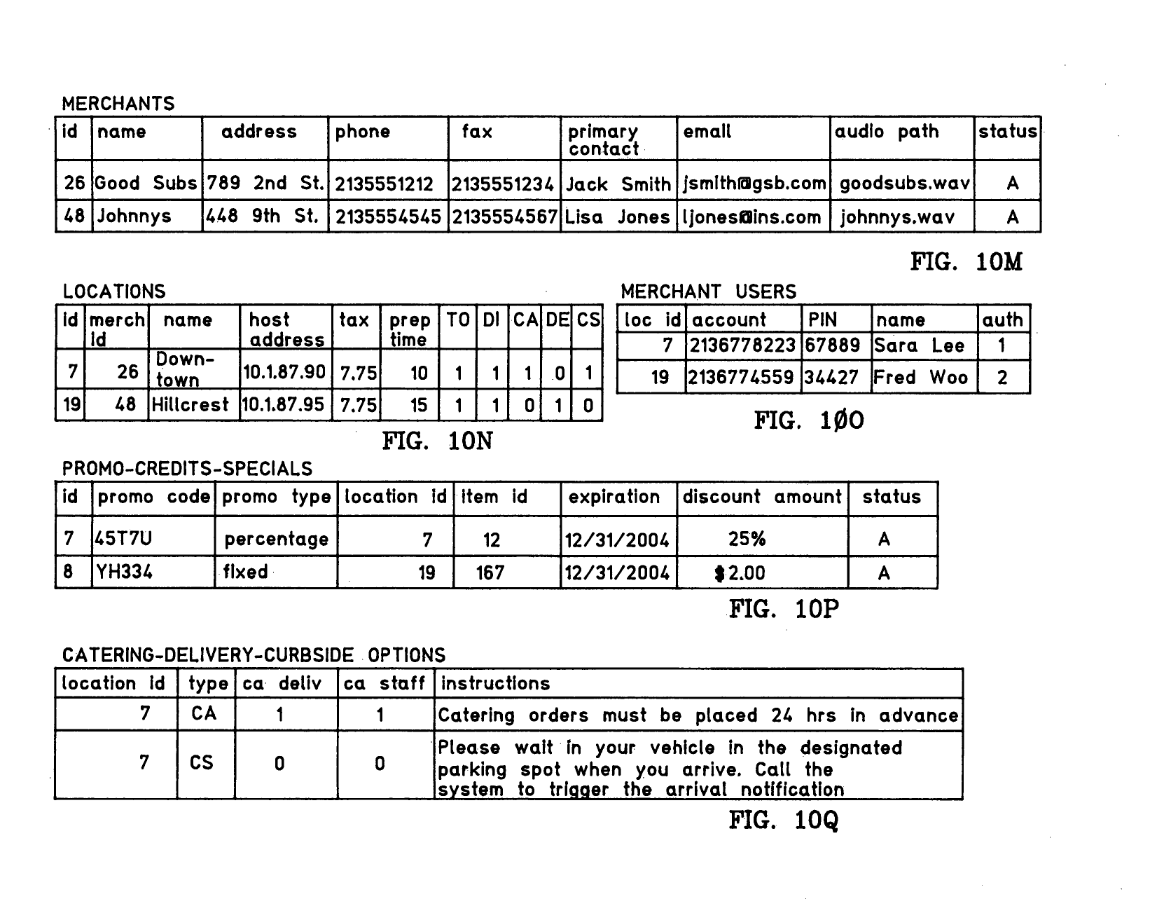

As exemplified in FIG. 10A, the user data 182 may include a unique ID, PIN, first name, last name, address, email, phone, balance, and credit balance, among other data fields. Preferably, the user ID field is the same as the user telephone number so that authentication can be expedited through caller identification detection during telephone access. According to ERD 178 and legend 180, each User links to one or more Payment Account data 184; each User links to one or more Vehicle data 186; each User links to one or more Favorite data 188; and each User links to one or more Order data 190.

As exemplified in FIG. 10B, Payment Account data 184 may include a unique ID, user ID (foreign key), payment type, bank name, account number, expiration date, first name, last name, and billing address.

As exemplified in FIG. 10C, Vehicle data 184 may include a unique ID, user ID (foreign key), make, model, color, and license number.

As exemplified in FIG. 10D, Favorite data 188 may include a unique ID, user ID (foreign key) and a favorite number. According to ERD 178 and legend 180, each Favorite links to one or more Favorite Item data.

As exemplified in FIG. 10E, the Favorite Item data 192 may include a unique ID, an item_id and an item_quantity. According to ERD 178 and legend 180, each Favorite Item links to one Item datum 194 and to one or more Favorite Options data 196, which may include a unique ID and an option_id. According to ERD 178 and legend 180, each Favorite Option links to one Option datum 198.

As exemplified in FIG. 10F, Orders data 190 may include a unique ID, user ID (foreign key), order number, order date, pickup time, subtotal, fee, tax, subtotal, location ID, status, order type, and vehicle ID. Optionally, Orders data 190 may also include a time due, contact phone, delivery address, people serving and staff count for delivery and catering orders. A “people serving” field may allow users to designate how many people the meal is feeding so the appropriate utensils may be provided, and a “staff count” field may allow merchants offering staffing for a catering event to request the appropriate number off servers for the catered event. According to ERD 178 and legend 180, each Order links to one or more Order Item data 200.

As exemplified in FIG. 10G, Order Item data 200 may include a unique ID, order ID (foreign key), item ID, name, receipt name, price, and quantity. According to ERD 178 and legend 180, each Order Item links to one Item datum 194 and to one or more Order Option data 202.

As exemplified in FIG. 10H, Order Option data 202 may include a unique ID, order item ID (foreign key), option ID, price. According to ERD 178 and legend 180, each Order Options links to one Option datum 198.

As exemplified in FIG. 10I, Item data 194 may include a unique ID, name, receipt name, price, UPC, description, audio path, location ID, outage flag, parent ID, category flag and a sorting number. According to ERD 178 and legend 180, one or more Items link to one or more Order Period data 204; each Item links to one or more Promos-Credits-Specials data 207; and one or more Items link to one or more Options data 198.

As exemplified in FIG. 10J, Order Period data 204 may include a unique ID, name, begin time, end time, and location ID. Order Periods table 204 is used to associate items with the time periods when they're available for ordering, such as breakfast or lunch.

As exemplified in FIG. 10L, Option data 198 may include a unique ID, parent ID, name, receipt name, audio path, price, is required, is pickone, is default and is out. According to ERD 178 and legend 180, one or more Options link to one or more Items data 194. In practice, an additional ‘options2items’ table should be provided to support the many-to-many relationship between Options data 198 and Items data 194, as any skilled practitioner in the database arts may readily appreciate. Such an options2items table should include at least two columns (item_id and option_id) but many other options fields may also be included in the options2items table to permit fields to vary with the associated item. The parent ID column allows unlimited hierarchies of option groups, such as the “breads” group with child items white, wheat, sourdough and rye. The “is required” field permits the merchant to make the option a required choice before the order may be completed. The “is pickone” field enables mutually-exclusive option groups, such as bread choices for a sandwich, where just one choice is valid. The “is default” field allows the merchant to set a default choice among a group of options, such as making “white bread” the default for the group “breads.” The “is out” field supports a merchant designation of an unavailable option.

As exemplified in FIG. 10M, the Merchant data 207 may include a unique ID, name, address, phone, fax, primary contact, email, audio path, and status. According to ERD 178 and legend 180, each Merchant links to one or more Location data 208 and to one or more Merchant User data 210.

As exemplified in FIG. 10N, Location data 208 may include a unique ID, merchant ID (foreign key), name, address, phone, fax, primary contact, email, audio path, status, terminal host address, tax rate, prep time, take-out flag, dine-in flag, catering flag, delivery flag, and curb-side flag (some fields are omitted from FIG. 10N). The terminal host field is the identifier (usually the IP address) that allows Business Logic Engine 26 to establish an Internet connection with the proper Merchant In-Store POS System 34. The prep time, as discussed earlier, is the amount of time the location has committed to taking to prepare any order, so that the user can predict accurately how far in advance they need to order. The take-out, dine-in, delivery, catering and curb-side flags serve to indicate whether the location supports each of those ordering types. According to ERD 178 and legend 180, each Location links to one or more Item data 194; each Location links to one or more Store Hours data 212; each Location links to one or more Order Periods data 204; each Location links to one or more Catering-Delivery-Curbside Options data 214; each Location links to one or more Promos-Credits-Specials data 206; and one or more Locations link to one or more Merchant Users data 210.

As exemplified in FIG. 10O, Merchant User data 210 may include a unique ID, location ID (foreign key), name, account number, name, and authorization level.

As exemplified in FIG. 10P, Promos-Credits-Specials data 206 may be spread across several tables, but essentially include a unique ID, promo code, promo type, location ID, user ID, item ID, expiration, discount amount and status field.

As exemplified in FIG. 10K, Store Hours data 212 may include a location ID, day, open time, close time, and a close for day flag As exemplified in FIG. 10Q, Catering-Delivery-Curbside Options data 214 may be spread across several tables, but essentially include a location ID (foreign key), order type, catering delivery flag, catering staff flag, and instructions.

The Precise Pickup Time Method:

FIG. 6A illustrates the machine-implemented method 216 of this invention whereby both user and merchant are provided with an exact and predictable pickup time for remotely-placed order. In the first step 218, the merchant must commit to a static preparation time (“prep time”) associated with a particular location. This prep time is a promise to prospective users that preparation of any food order must be completed no later than the prep time interval following order placement and receipt through food order fulfillment system 20, and should be established by management to include any effects of the busiest periods for the location. For example, the merchant may experiment with the prep time commitment by, for example, adjusting it in five-minute increments at first to eventually find the lowest reasonable prep time for the location. Advantageously, because Merchant In-Store POS System 34 immediately notifies store employees of each incoming order and because no buffer time is needed to account for failed transmissions, this prep time parameter may be reasonably set as low as ten minutes for merchants in the Quick Service Restaurant (QSR) or fast food categories. This important element of the method of this invention resolves the waiting time imposed by prior art systems on the many users who do not decide what to order or where to place the order until the last minute. FIG. 6B shows an exemplary food vendor data structure that includes the prep time for each location, which is preferably stored in database 38 (FIG. 1).

Referring again to FIG. 6A, in the next step 220, the prep time established for each merchant location is exposed to prospective users through system 20, for example, by GUI display exemplified in FIG. 6C or by means of VoiceXML IVR, responsive to user survey of available merchant locations or a saved “favorite,” for example. With the prep time in mind, the user finishes building their order and goes through the payment process in the step 222, which then proceeds to the final ordering step 224 for order transmission to the selected restaurant location. At step 224, the user is once again notified of the prep time for the prospective order by means of, for example, a GUI display exemplified by FIG. 6D, before finally confirming and transmitting the food order. Once the user has transmitted the order, a precise pickup time is generated by adding the associated prep time to the current system time (order placement time) and the order is transmitted in real-time to the Merchant In-Store POS System 34. If the transmission is successful, a confirmation is displayed to the user in the final step 226, which includes the exact pickup time for the food order, together with, for example, instructions for expediting the order fulfillment at the pickup time.

The ID Pickup Method:

FIG. 7 illustrates the walk-in ID pick-up method 228 of this invention, which is an embodiment of step 122 (FIG. 2) that expedites the in-store or curbside transactions between merchants and users. Advantageously, because food order fulfillment system 20 collects the detailed order information and payment from the user in advance and calculates a precise pickup time, the transaction may be fulfilled at the pickup location merely by delivering the completed food order to the user, subject to identity verification. According to the method of this invention, user identity may be verified, for example, by scanning a picture identification (“ID”) for comparison to the associated user information (e.g., user name data for receipt 130). Advantageously, system security is thereby improved and order fulfillment (pickup) may be significantly expedited, especially in stores without a separate pickup area for remotely-placed orders. By suggesting that users have their picture ID in hand and visible upon arrival and by training store attendants to look for such users around the scheduled pickup time, ID Pickup method 228 ensures the fastest possible order fulfillment, without disrupting the transactions of non-user customers waiting in line to order and/or pay. Method 228 is especially advantageous for locations without separate registers and staff supporting remote order fulfillment where users are obliged to “cut” into line to pickup a food order.

In FIG. 7, for walk-ins, ID Pickup method 228 begins at the first step 230 when the user arrives at the store. Preferably, each location includes a special sign designating a pickup area inside the store for remote orders. At the next step 232, the user proceeds directly to this designated pickup area, and disposes a picture ID visibly to the store staff in the step 234. The staff may then associate a possible user with ID in hand to a completed food order, even when transacting with another customer outside of user voice range. As soon as possible, in the next step 236, the proffered user ID is scanned for comparison to the user identity information received with the food order and the order is given to the user to complete fulfillment at the last step 238. Step 236 is preferably a machine-executed step performed by means of, for example, scanning device 126 (FIG. 3A) at POS System 34, but may be performed in any other useful manner known in the art, without limitation. Many useful machine-implemented ID verification systems are known to practitioners skilled in the electronic arts, including low-frequency passive card readers, bar code scanners, optical character recognition scanners, biometric scanners (e.g., thumb-print, iris, etc) smart-chip interface scanners, for example. Alternatively, a user password may be entered at POS System 34 to verify user identity, for example. As described herein, step 234 is not considered to be an element of the user verification method of this invention and is suggested merely as a particularly advantageous method for expediting fulfillment.

With the low prep-time possible in food order fulfillment system 20, opportunities for the user to have a change of mind is also minimized, in part because the final order transmission step 102 (FIG. 2) notifies the user that the order cannot be canceled or modified once placed. Because the order is prepaid, regardless of whether the user takes delivery, order cancellations are also rare. These factors make it possible to operate food order fulfillment system 20 assuming that all transmitted orders are fulfilled. In the rare case when the merchant must cancel a remotely-placed order, Merchant In-Store POS System 34 may be used to notify Business Logic Engine 26 of the order cancellation with a few simple steps (not shown). Thus, when an attendant hands over the food order, the transaction is truly finished. Should the merchant wish to clear the order from the orders list display in Merchant In-Store POS System 34, it may be marked as “done,” thus removing it from the list of active orders, for example, but such action is not needed to notify food order fulfillment system 20 of the completed order fulfillment.

FIG. 8 illustrates the curbside ID pick-up method 240, which is an embodiment of step 122 (FIG. 2) that expedites the in-store or curbside transactions between merchants and users. Curbside ID Pickup method 240 begins at the first step 242 when the user arrives at the store parking lot or closest street in their vehicle. In the next step 244, the arrived user uses, for example, a cell phone to connect with IVR system 48 (FIG. 1), which prompts the user to notify the merchant location of the arrival for pickup, by means of, for example, depressing a cell phone key. At the step 246, when the user hits the appropriate phone keypad key to trigger the notification, Business Logic Engine 26 uses, for example, order transmission process 108 described above in connection with FIG. 2 to transmit an arrival notification message to Merchant In-Store POS System 34. At the next step 248, when Merchant In-Store POS System 34 receives the arrival notification message, a special audible alert is sounded to notify staff of the user waiting in a vehicle for curbside order fulfillment. Preferably, the alert is sounded every 20 seconds until affirmatively acknowledged by depressing a button at Merchant In-Store POS System 34. In the next step 250, the user identity is verified by comparison to the user information included in the food order transmission according to any useful method known in the art, including, for example, the entry of an agreed PIN or passcode at step 244, a vehicle license plate scan, a vehicle smart-card transponder query, or the like without limitation. In the final fulfillment step 252, an attendant carries the completed food order together with the printed receipt out to the waiting user vehicle. The attendant identifies the proper vehicle by means of, for example, a vehicle description submitted as part of the user identification information with the food order including, for example, vehicle make, model, color and license plate. Alternatively, the name on the printed receipt is compared with a picture ID proffered by the user to complete step 252.

Clearly, other embodiments and modifications of this invention may occur readily to those of ordinary skill in the art in view of these teachings. Therefore, this invention is to be limited only by the following claims, which include all such embodiments and modifications when viewed in conjunction with the above specification and accompanying drawing.

We claim:

1-8. (canceled)

9. A system for the processing of a food order from a user, the system comprising:
an in-store point-of-sale (POS) system including
reception means for receiving a wireless signal representing digital data corresponding to the food order and the user identity
printer means for printing the food order to produce a permanent record thereof and
processor means for adding the food order into a food order database;
order acceptance means for accepting the food order from the user, including
first means for displaying a plurality of food merchants,
second means for accepting a merchant selection from the user,
third means for displaying a merchant menu that includes merchant inventory availability and pricing data,
fourth means for accepting a menu item selection from the user,
fifth means for displaying a merchant preparation time for the food order, and
sixth means for debiting a user account for the price of the food order;
confirmation means for establishing a pick-up time and a pick-up location for the food order, including
first means for receiving from the in-store POS system a wireless signal representing digital data corresponding to a confirmation of receipt of the food order by the selected merchant, and
second means for displaying the pick-up time for the food order; and fulfillment means for fulfilling the food order for the user at the order pickup location.

10. The system of claim 9, the fulfillment means further comprising:
first means for displaying a confirmation of the user identity.

11. The system of claim 10, the first fulfillment means further comprising:
scanner means for scanning a user identification means;
processor means for generating a digital signal representing the user identity; and
comparison means for comparing the user identity to the user identification means.

12. The system of claim 11, the scanner means further comprising:
vehicle scanner means for scanning a motor vehicle representing the user identification means.

13. The system of claim 9 wherein:
the first order acceptance means includes means for displaying one or more stored user preselections; and
the fourth order acceptance means includes means for accepting a selection of a stored user preselected menu item from the user.

14. The system of claim 13,the second order acceptance means further comprising:
means for accepting a selection of a stored user preselected merchant from the user.

15. The system of claim 9, the third order acceptance means further comprising:
means for displaying a merchant menu that includes at least one item that is designated as being temporarily unavailable.

16. The system of claim 9, the order acceptance means further comprising:
seventh means for displaying customizing options for the menu item selection; and
eighth means for accepting a customizing option selection from the user.

17. A point-of-sale (POS) system for use in a system for the processing of a food order from a user, the POS system comprising:
reception means for receiving a wireless signal representing digital data corresponding to the food order;
printer means for printing the food order to produce a permanent record thereof; and
processor means for adding the food order into a food order database.

18. The system of claim 17 further comprising:
transmission means for generating a wireless signal representing a confirmation message that includes an order pick-up time.

19. The system of claim 18 further comprising:
address means for generating routing data sufficient to route the confirmation message to the user.
